(19) United States
(12) Patent Application Publication
(10) Pub. No.: US 2026/0061923 A1
(43) Pub. Date: Mar. 5, 2026

(54) TRAILER WITH SPRING ASSISTED RAMP

(71) Applicant: Southland Trailer Corp., Lethbridge (CA)

(72) Inventors: Adrian Jones, Raymond (CA); Seth Tams, Lethbridge (CA)

(21) Appl. No.: 18/818,883

(22) Filed: Aug. 29, 2024

(51) Int. Cl. B60P 1/43; B65G 69/28

(52) U.S. Cl. CPC B60P 1/433; B60P 1/438; B65G 69/28

(57) ABSTRACT

A transport vehicle, such as a trailer, is provided. The transport vehicle has: ground engaging elements; a body carried by the ground engaging elements and having a load supporting surface; a ramp rotatably coupled to the body, the ramp being rotatable about a ramp axis between a closed position and an open position; a spring assembly coupled to and extending between the body and the ramp, the spring assembly exerting a spring force on the ramp along a force axis. The spring force biases the ramp towards a balanced position located between the closed position and the open position. The spring assembly moves as the ramp rotates between the closed position and the open position such that the force axis passes by above the ramp axis in the closed position, passes through the ramp axis in the balanced position, and passes below the ramp axis in the open position.

### FIELD

The subject disclosure generally relates to vehicles with ramps, and more particularly to a trailer with ramp and spring assembly.

### BACKGROUND

Heavy duty trailers for transporting vehicles or other equipment, such as industrial, recreational, or agricultural equipment are well known. These trailers generally include one or more ramps to assist with loading and unloading the equipment. Since these ramps must support most, if not all, of the weight of the equipment as it is loaded or unloaded, the ramps are typically quite heavy and can weigh over 100 lbs.

To facilitate opening and closing of the ramps, some trailers include hydraulic or pneumatic systems that rotate the ramps between open and closed positions. However, these systems can be complex and require a power source, such as a pump, to operate. This can increase maintenance and operating costs of the trailer. Accordingly, some trailers include springs to assist a user with manually opening and closing the ramps.

U.S. Patent Application No. 2002/0081185 discloses a trailer with a spring assisted ramp. The trailer includes a first pair of springs that bias the ramp from an unloading disposition towards a neutral disposition, and includes a second pair of springs that bias the ramp from a transport disposition to the neutral disposition. Regardless of whether the ramp is in the loading disposition or the transport disposition, either the first pair of springs or the second pair of springs assist the user in accomplishing rotation from one disposition to another.

While the contributions of known trailers are laudable, improvements and alternatives are generally desired. It is therefore an object of this disclosure to provide a novel trailer with a spring assisted ramp.

### SUMMARY

It should be appreciated that this summary is provided to introduce a selection of concepts that are further described below in the detailed description of embodiments. This summary is not intended to be used to limit the scope of the claimed subject matter.

Accordingly, in an aspect, there is provided a transport vehicle, such as a trailer, comprising: a plurality of ground engaging elements; a body carried by the ground engaging elements, the body having a load supporting surface; a ramp rotatably coupled to the body, the ramp being rotatable about a ramp axis between a closed position and an open position; a spring assembly coupled to and extending between the body and the ramp, the spring assembly exerting a spring force on the ramp along a force axis, the spring force biasing the ramp towards a balanced position located between the closed position and the open position, wherein the spring assembly moves as the ramp rotates between the closed position and the open position such that the force axis passes by a first side of the ramp axis in the closed position, passes through the ramp axis in the balanced position, and passes by a second, opposite side of the ramp axis in the open position.

In one or more embodiments, the spring force biases the ramp towards the balanced position both when the ramp is in the closed position and when the ramp is in the open position. In some embodiments, the force axis passes above the ramp axis in the closed position, and passes below the ramp axis in the open position.

In one or more embodiments, the spring assembly is coupled to the body at a body connection point, the spring assembly is coupled to the ramp at a ramp connection point, and a line between the body connection point and the ramp connection point defines the force axis. The body connection point may be positioned vertically lower than the ramp axis. The ramp connection point may be positioned vertically higher than the ramp axis when the ramp is in the closed position, and may be positioned vertically lower than the ramp axis when the ramp is in the open position. The spring force may push the body connection point away from the ramp connection point, when the spring assembly is compressed.

In one or more embodiments, the spring assembly comprises a gas spring that generates the spring force when compressed. In some embodiments, the spring assembly comprises a compression spring that generates the spring force when compressed.

In one or more embodiments, the ramp comprises a lifting handle and the spring force is configured such that a maximum lifting force that the user must exert at a middle of the lifting handle to rotate the ramp from the closed position to the open position, or vice versa, does not exceed approximately 50 lbs.

In one or more embodiments, the maximum lifting force corresponds with the ramp being located at a position that is between a max moment position and the balanced position, wherein a center of mass of the ramp is approximately directly above the ramp axis when the ramp is in the balanced position, and wherein the center of mass of the ramp is approximately horizontally aligned with the ramp axis at the max moment position.

In one or more embodiments, a center of mass of the ramp is approximately directly above the ramp axis when the ramp is in the balanced position.

In one or more embodiments, the spring assembly is fully extended when the ramp is in the balanced position, such that the spring assembly exerts approximately no spring force on the ramp when the ramp is in the balanced position.

In one or more embodiments, the ramp rests against the load supporting surface of the body when the ramp is in the closed position.

In one or more embodiments, the spring assembly dampens rotation of the ramp between the closed position and the open position. In some embodiments, the damping of the spring assembly is configured to stop rotation of the ramp before the open position, when the ramp is released to fall freely from the balanced position towards the open position.

In one or more embodiments, the ramp is rotatably coupled to the body by a hinge assembly, and wherein the hinge assembly comprises a single rotational joint that defines the ramp axis.

In one or more embodiments, the ramp rotates about the ramp axis by an angle greater than 90 degrees as the ramp rotates between the closed position and the open position.

In one or more embodiments, the ramp rotates about the ramp axis by an angle of approximately 180 degrees as the ramp rotates between the closed position and the open position.

### BRIEF DESCRIPTION OF THE DRAWINGS

Embodiments will now be described more fully with reference to the accompanying drawings, in which:

FIG. 1 is an isometric view of a trailer, with a ramp of the trailer in the closed position;

FIG. 2 is an isometric view of the trailer of FIG. 1, with the ramp in a balanced position;

FIG. 3 is an isometric view of the trailer of FIG. 1, with the ramp in a max moment position;

FIG. 4 is an isometric view of the trailer of FIG. 1, with the ramp in an open position;

FIG. 5 is a left side view of the trailer of FIG. 1;

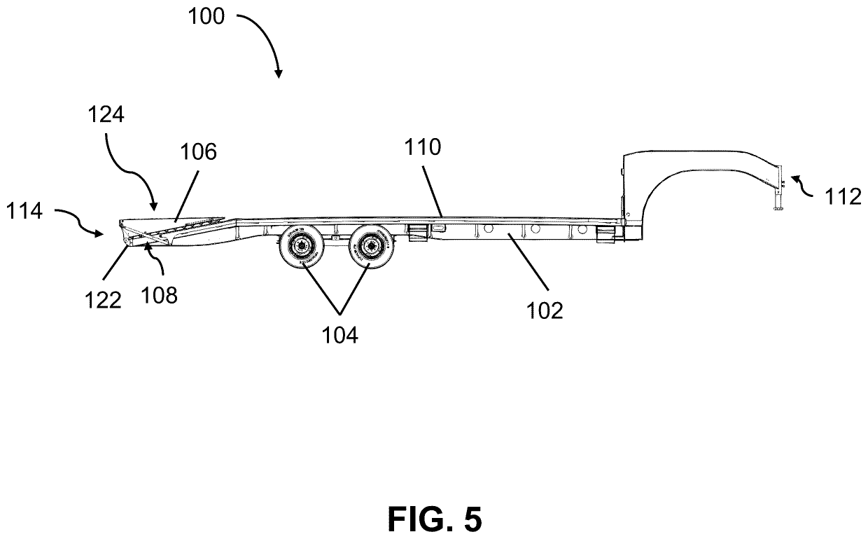

FIG. 6 is a right side view of the trailer of FIG. 1, with the ramp in the closed position;

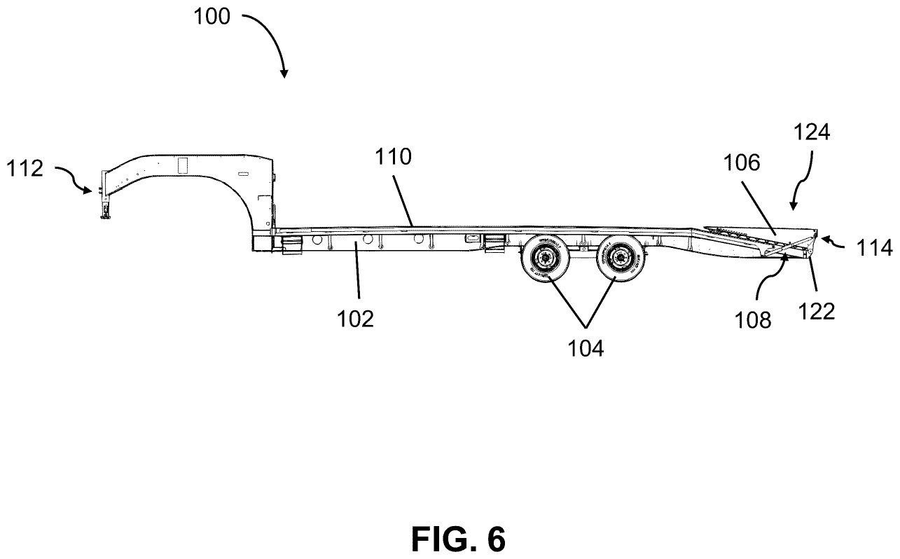

FIG. 7 is a right side view of the trailer of FIG. 1, with the ramp in the balanced position;

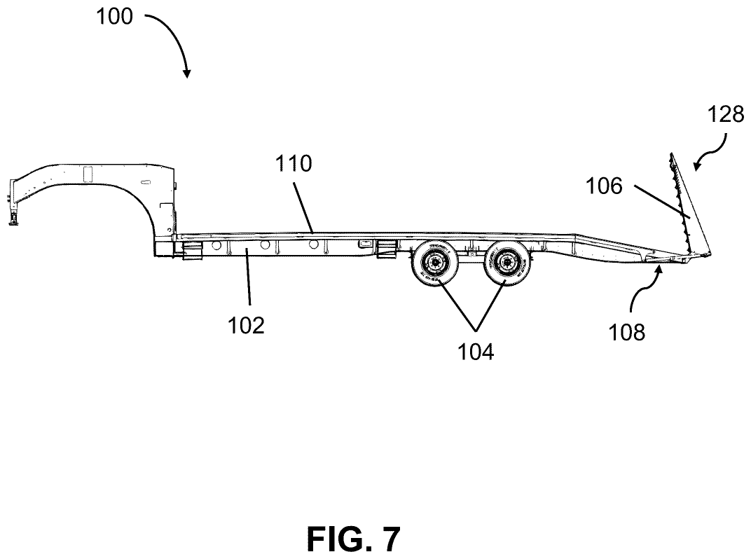

FIG. 8 is a right side view of the trailer of FIG. 1, with the ramp in the max moment position;

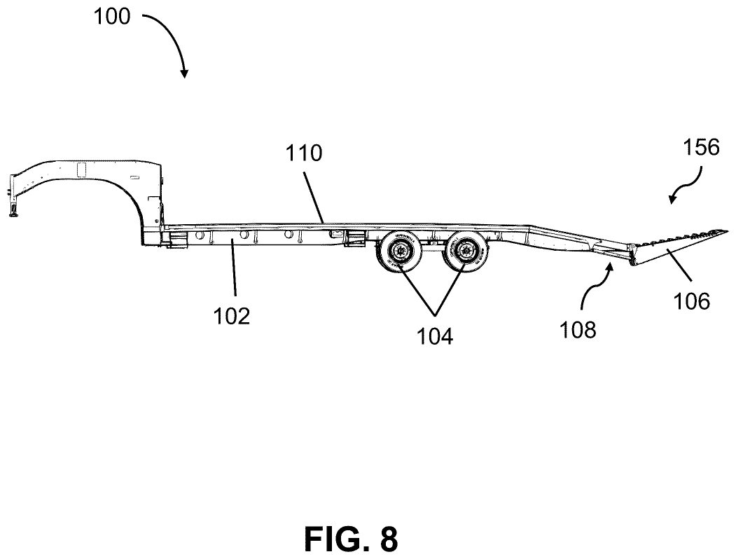

FIG. 9 is a right side view of the trailer of FIG. 1, with the ramp in the open position;

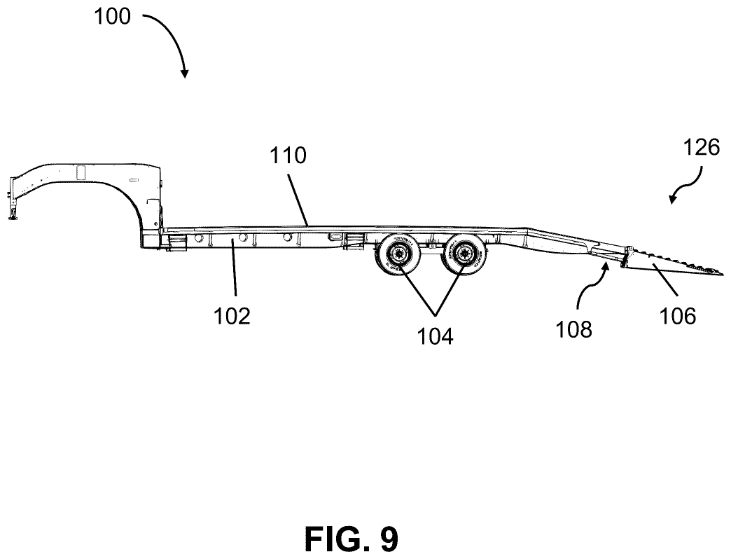

FIG. 10 is a detail view of a rear end of the trailer of FIG. 1, with the ramp in the closed position;

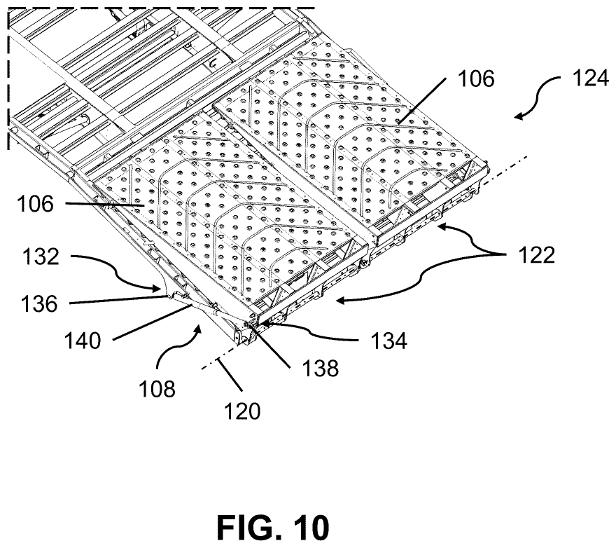

FIG. 11 is a detail view of the rear end of the trailer of FIG. 1, with the ramp in the balanced position;

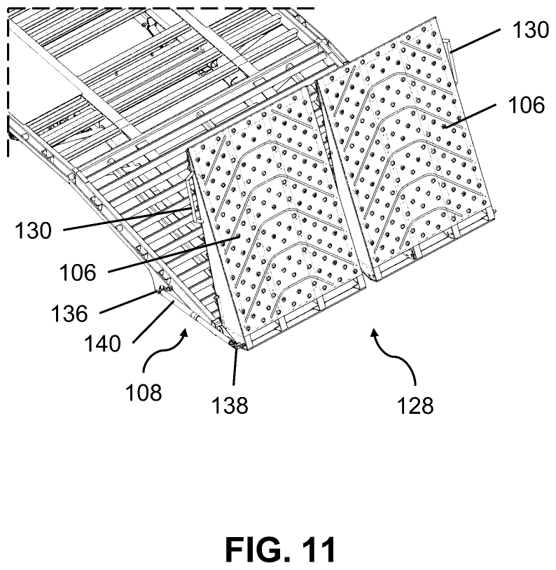

FIG. 12 is a detail view of the rear end of the trailer of FIG. 1, with the ramp in the max moment position;

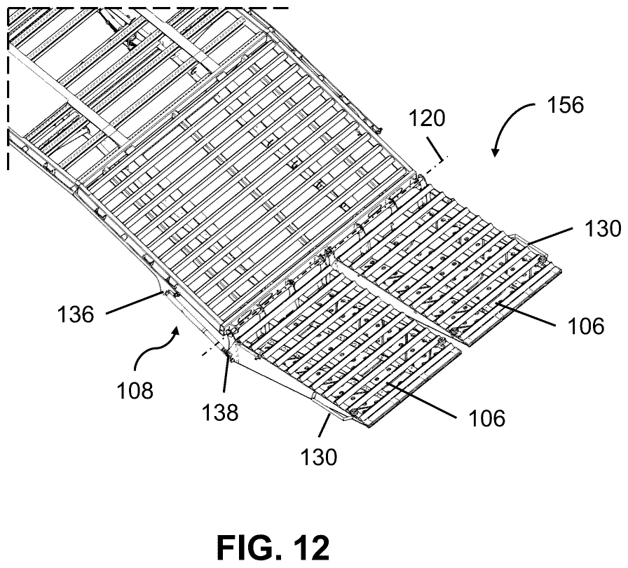

FIG. 13 is a detail view of the rear end of the trailer of FIG. 1, with the ramp in the open position;

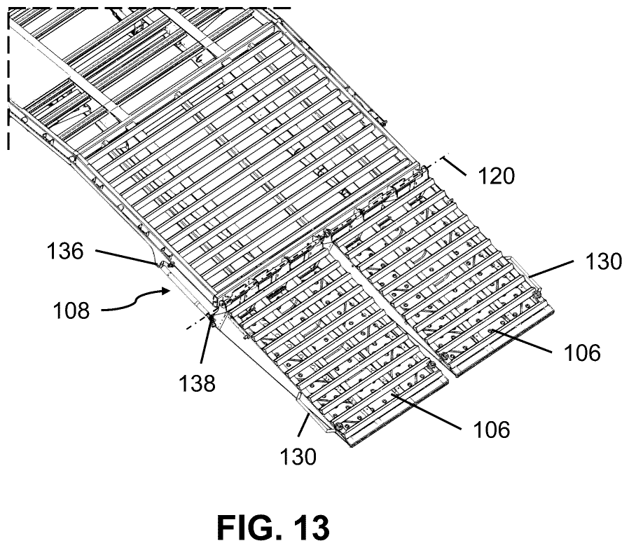

FIG. 14 is a side detail view of the rear end of the trailer of FIG. 1, showing a spring assembly and the ramp in the closed position;

FIG. 15 is a side detail view of the rear end of the trailer of FIG. 1, showing the spring assembly and the ramp in the balanced position;

FIG. 16 is a side detail view of the rear end of the trailer of FIG. 1, showing the spring assembly and the ramp in the max moment position; and

FIG. 17 is a side detail view of the rear end of the trailer of FIG. 1, showing the spring assembly and the ramp in the open position.

### DETAILED DESCRIPTION OF EMBODIMENTS

The foregoing summary, as well as the following detailed description of embodiments will be better understood when read in conjunction with the accompanying drawings.

As used herein, an element or feature described in the singular and preceded by the word “a” or “an” should be understood as not necessarily excluding a plural of the elements or features. Further, references to “one example” or “one embodiment” are not intended to be interpreted as excluding the existence of additional examples or embodiments that also incorporate the described elements or features of that one example or one embodiment. As used herein, the term “and/or” can include any and all combinations of one or more of the associated listed elements or features. Moreover, it will be appreciated that the terms “comprises”, “has”, and “includes” mean “including but not limited to” and the terms “comprising”, “having”, and “including” have equivalent meanings.

Reference herein to the phrases “an example”, “another example”, and similar language throughout the subject disclosure may, but do not necessarily, refer to the same example.

Unless otherwise indicated, the terms “first”, “second”, etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third”item).

It will be understood that spatially relative terms, such as “under”, “below”, “lower” “over”, “above”, “upper”, “front”, “back”, and the like, may be used herein for ease of describing the relationship of an element or feature to another element or feature as depicted in the figures. The spatially relative terms can, however, encompass different orientations in use or operation in addition to the orientation depicted in the figures.

As used herein, the terms “approximately”, “substantially”, “generally”, and “about” represent an amount or condition close to the stated amount or condition that results in the desired function being performed or the desired result being achieved. For example, the terms “approximately”, “substantially”, “generally”, and “about” may refer to an amount that is within engineering tolerances to the precise value specified, as would be appreciated by a person skilled in the art.

Reference herein to “configured” denotes an actual state of configuration that fundamentally ties the element or feature to the physical characteristics of the element or feature preceding the phrase “configured”. Thus, “configured” means that the element or feature is designed and/or intended to perform a given function and should not be construed to include an element or feature that is merely capable of performing the given function but was not intended for that purpose.

Trailers with spring assisted ramps are generally known. As the name suggests, these trailers use springs to assist users with manually opening and closing the ramps when loading or unloading the trailers. However, existing spring assisted ramps, such at the one described in U.S. Patent Application No. 2002/0081185, use at least two torsion springs per ramp to assist the user. These torsion springs are located in the hinge mechanism of the ramp, and may be wrapped around an axle in the hinge mechanism. This existing design can make it challenging to access the springs for maintenance. Additionally, it may not be possible to remove the torsion springs (such as to replace the springs) without completely disassembling the hinge mechanism and removing the ramp from the trailer, which can be time consuming and may be difficult due to the considerable weight of such ramps. Accordingly, it is an object of the present disclosure to provide a trailer with spring assisted ramps where the springs are readily accessible for maintenance and/or removal, and preferably where only a single spring is used per ramp.

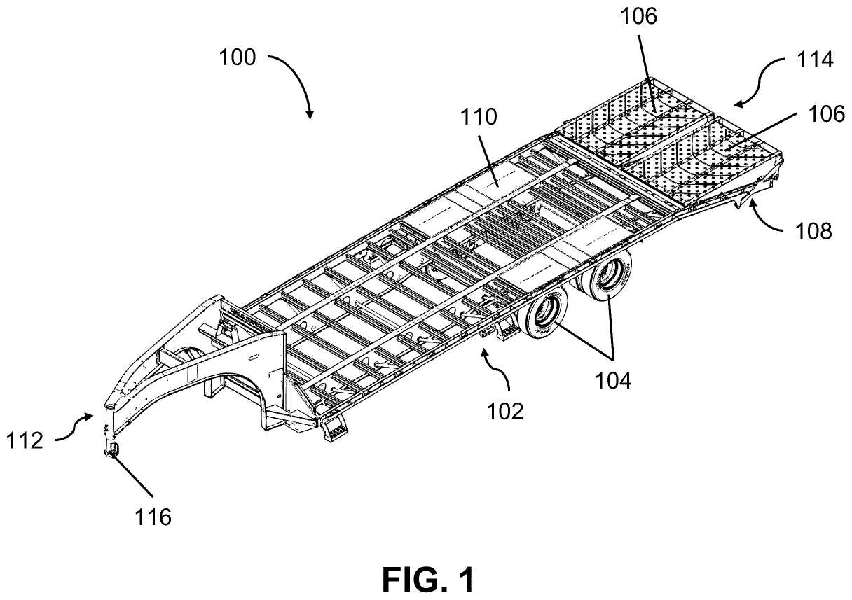

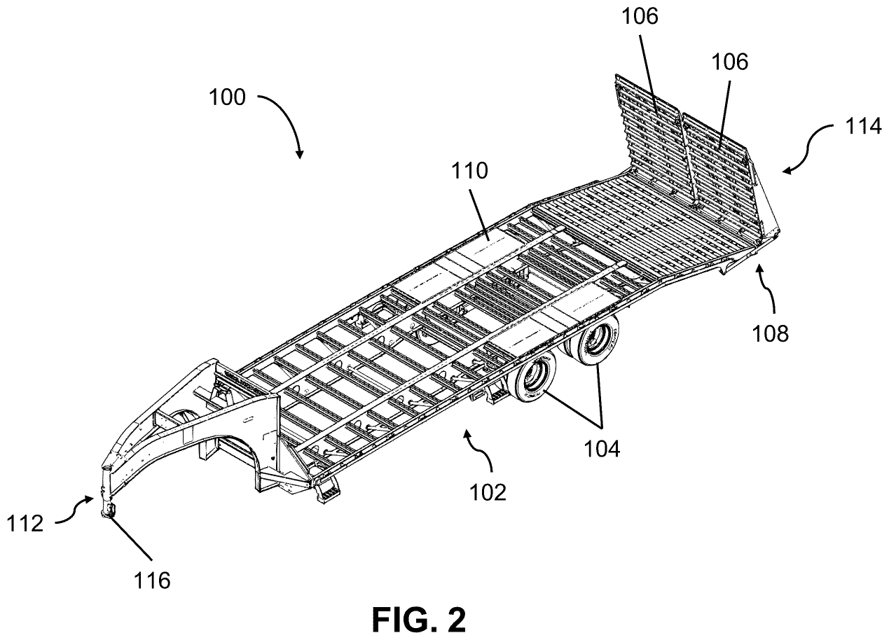

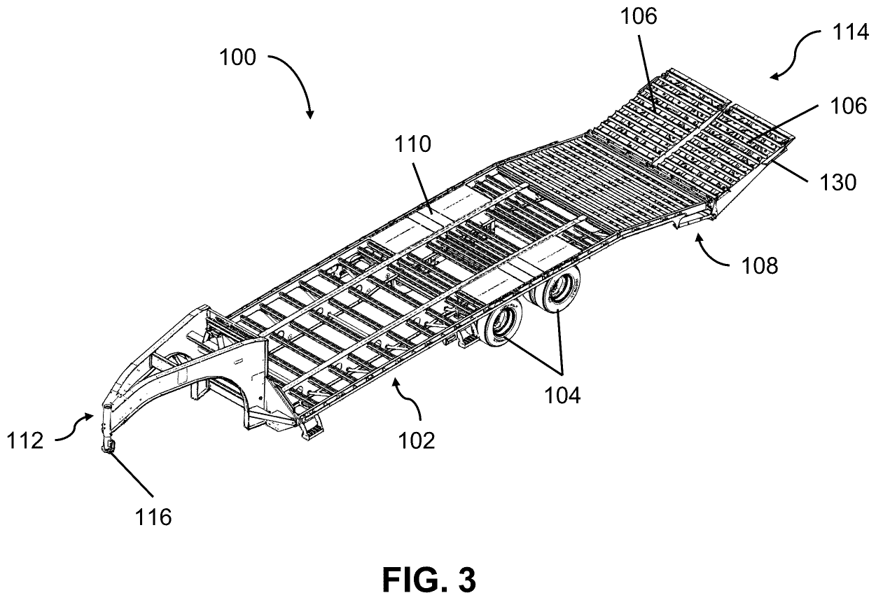

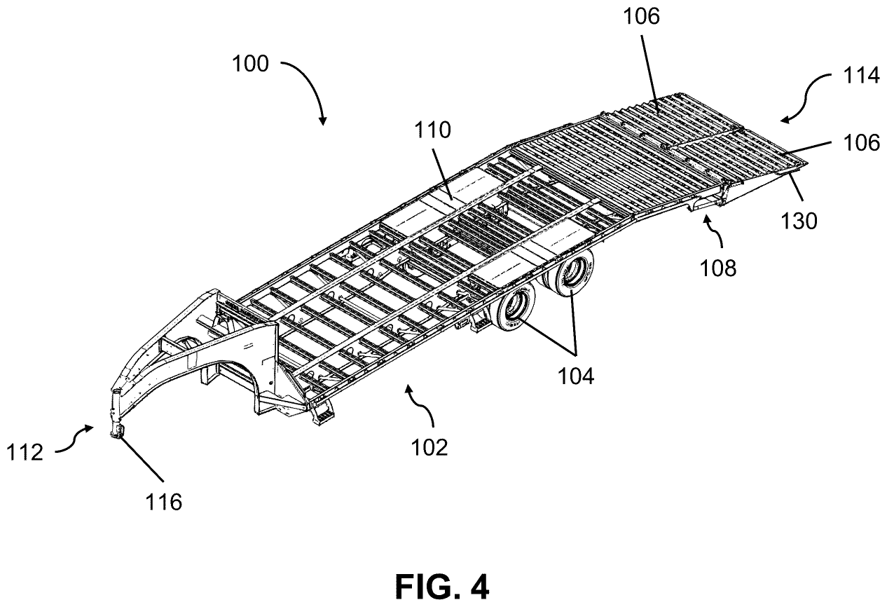

FIGS. 1 to 4 show an embodiment of a trailer, generally identified by reference character 100. The trailer 100 comprises a body 102, a plurality of ground engaging elements 104, a pair of ramps 106, and a corresponding pair of spring assemblies 108. The trailer 100 is configured to be towed behind a truck or other vehicle. The trailer 100 can be used to transport loads between locations, such as to transport one or more vehicles or other equipment between a jobsite and a storage location.

The trailer 100 is supported on the ground engaging elements 104 as it moves. The ground engaging elements 104 are coupled beneath the body 102 and carry the body 102 as it is towed along the ground. The ground engaging elements 104 comprise a plurality of wheels that are rotatably coupled to the body 102 by conventional means known in the art, such as a conventional suspension system.

The body 102 is configured to support the load as it is transported between locations. The body 102 comprises a load supporting surface 110 for supporting the load. The body 102 extends in a longitudinal direction from a front end 112 to a rear end 114. The body 102 comprises a coupler 116 at the front end 112, for coupling the trailer 100 to a hitch of a truck or other vehicle. The ramps 106 are coupled to the rear end 114 of the body 102.

The ramps 106 are configured to assist with loading and unloading the trailer 100. In the subject embodiment, the ramps 106 are mirror images of each other. Accordingly, for brevity, only one of the ramps 106 is described in detail herein.

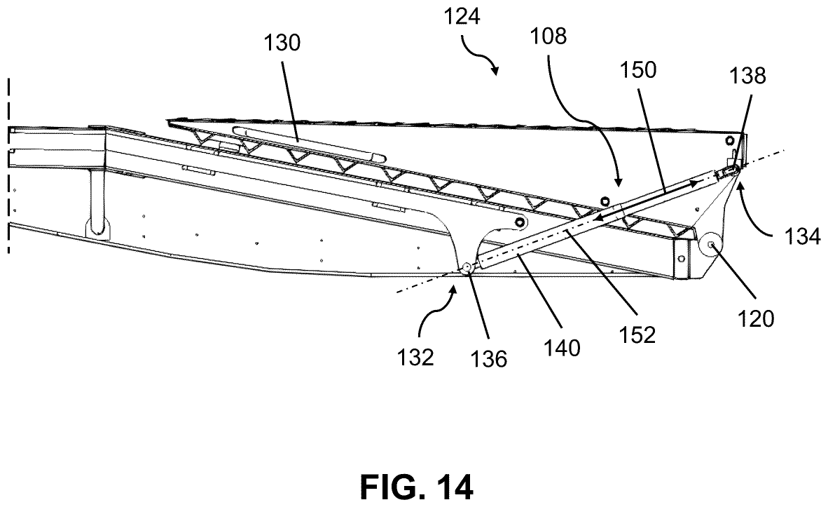

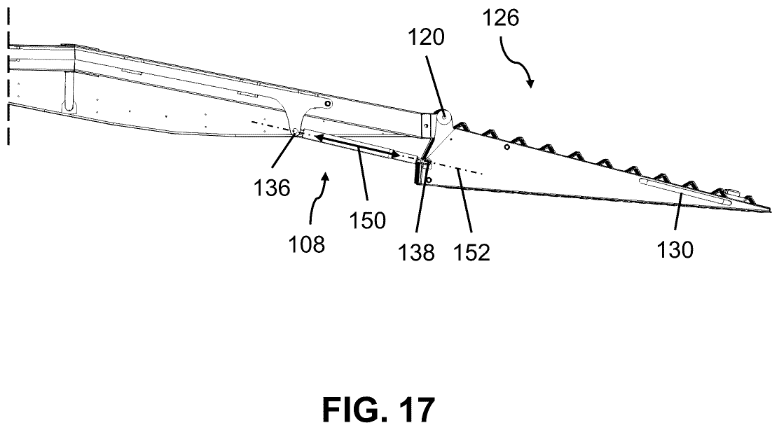

The ramp 106 is rotatably coupled to the body 102 at a ramp axis 120. The ramp axis 120 is generally perpendicular to the longitudinal direction of the body 102. The ramp 106 is rotatably coupled to the body 102 by a hinge assembly 122. The hinge assembly 122 comprises a single rotational joint that defines the ramp axis 120. The ramp 106 is rotatable between a closed position 124 (shown in FIG. 14) and an open position 126 (shown in FIG. 17). The ramp 106 rotates about the ramp axis 120 by an angle greater than 100 degrees as the ramp 106 rotates between the closed position 124 and the open position 126. Preferably, the ramp 106 rotates about the ramp axis 120 by an angle of approximately 180 degrees as the ramp 106 rotates between the closed position 124 and the open position 126. The ramp 106 is maintained in the closed position 124 during transportation, and is moved by a user to the open position 126 during loading and unloading of the trailer 100. The ramp 106 comprises a lifting handle 130, which the user can grasp when rotating the ramp 106 from the closed position 124 to the open position 126 or vise versa. The ramp 106 rests against the load supporting surface 110 when the ramp 106 is in the closed position 124. The ramp 106 extends generally from the ground to the load supporting surface 110 when the ramp is in the open position 126, to allow a vehicle or other equipment to be easily loaded and unloaded from the trailer 100.

To facilitate a user with opening and closing the ramps 106, the trailer 100 comprises a spring assembly 108 for each ramp 106. Similar to the ramps 106, the spring assemblies 108 are mirror images of each other. Accordingly, for brevity, only one of the spring assemblies 108 is described in detail herein.

The spring assembly 108 is coupled to and extends between the body 102 and the ramp 106. The spring assembly 108 extends in an axial direction from a first end 132 to an opposite, second end 134. The first end 132 of the spring assembly 108 is rotatably coupled to the body 102 at a body connection point 136. The second end 134 of the spring assembly 108 is rotatably coupled to the ramp 106 at a ramp connection point 138. The body connection point 136 is positioned vertically lower than the ramp axis 120 and is fixed in place with respect to the body 102. On the other hand, the ramp connection point 138 moves with respect to the body 102 as the ramp 106 rotates about the ramp axis 120, such that the ramp connection point 138 is positioned vertically higher than the ramp axis 120 when the ramp 106 is in the closed position 124 (see FIG. 14), and is positioned vertically lower than the ramp axis 120 when the ramp 106 is in the open position 126 (see FIG. 17).

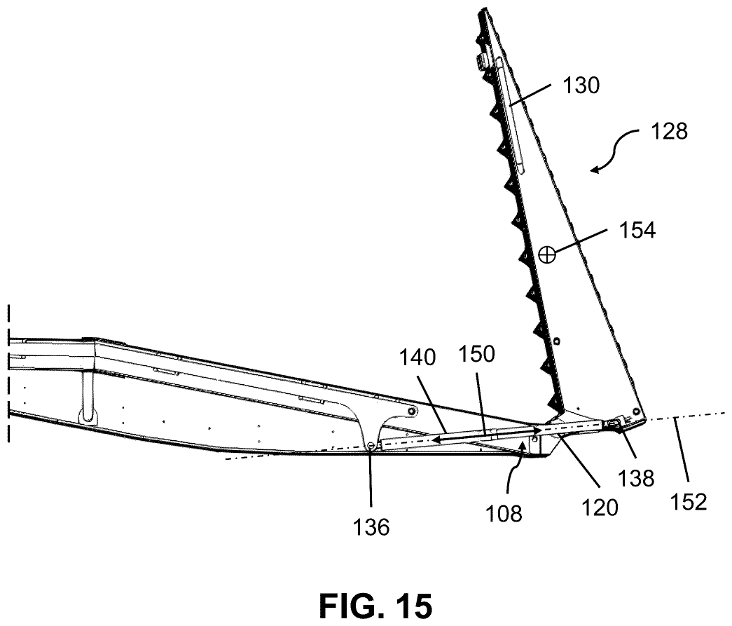

The spring assembly 108 is configured to assist a user with rotating the ramp 106 from the closed position 124 to the open position 126, and vice versa. The spring assembly 108 exerts a spring force 150 on the ramp 106. The spring force 150 biases the ramp 106 towards a balanced position 128 (shown in FIG. 15), which is located between the closed position 124 and the open position 126. In the subject embodiment, the spring force 150 biases the ramp 106 towards the balanced position 128 both when the ramp 106 is in the closed position 124 and when the ramp 106 is in the open position 126. Accordingly, the spring assembly 108 can assist a user with opening the ramp 106 and also with closing the ramp 106, as described in greater detail below.

The spring assembly 108 comprises a gas spring 140 that generates the spring force 150. In other embodiments, the spring assembly 108 may comprise a compression spring to generate the spring force 150. In the subject embodiment, the spring assembly 108 is arranged such that the spring force 150 resists compression of the spring assembly 108. That is, the spring force 150 pushes the ramp connection point 138 away from the body connection point 136 to minimize compression of the spring assembly 108.

The spring force 150 acts along a force axis 152 (as shown in FIGS. 14 to 17). In the subject embodiment, the force axis 152 is defined by a line that extends between the body connection point 136 and the ramp connection point 138. As discussed above, the ramp connection point 138 moves as the ramp 106 rotates about the ramp axis 120. Accordingly, the spring assembly 108 and the force axis 152 both move as the ramp 106 rotates between the closed position 124 and the open position 126. More particularly, the spring assembly 108 moves as the ramp 106 rotates between the closed position 124 and the open position 126, such that the force axis 152 passes by a first side of the ramp axis 120 in the closed position 124, passes through the ramp axis 120 in the balanced position 128, and passes by a second, opposite side of the ramp axis 120 in the open position 126. In the subject embodiment, the force axis 152 passes above the ramp axis 120 in the closed position 124, and passes below the ramp axis 120 in the open position 126. Accordingly, in this embodiment, the first side of the ramp axis 120 is the top side, and the second side of the ramp axis 120 is the bottom side.

The operation of the ramp 106 and spring assembly 108 will now be described in greater detail with reference to FIGS. 14 to 17. Directions of motion, such as right, left, clockwise, and counterclockwise, are used in the context of those figures and it will be appreciated that such direction will be reversed for the ramp and the spring assembly that are on the opposite side of the trailer 100, which are mirror images of those in FIGS. 14 to 17.

During operation, a user can rotate the ramp 106 from the closed position 124 to the open position 126, and vice versa, by exerting a manual force on the ramp 106 (such as by pulling or pushing on the ramp 106). The force the user is required to exert on the ramp 106 to rotate the ramp 106 upward (i.e., toward the balanced position 128) is defined as the “apparent weight” of the ramp 106. As will be appreciated, the apparent weight of the ramp 106 will depend on at least the force of gravity and the spring force 150 acting on the ramp 106. Additionally, the apparent weight will depend on the location where the user pulls or pushes on the ramp 106. To facilitate understanding, the apparent weight of the ramp 106 is described herein with respect to pulling or pushing on a middle of the lifting handle 130 of the ramp 106. However, it will be appreciated that the apparent weight may be more or less than the amounts described below, if the user pulls or pushes on a location that is closer to or farther away from the ramp axis 120, respectively.

FIG. 14 shows the ramp 106 in the closed position 124. When the ramp 106 is in the closed position 124, the spring assembly 108 is compressed and the spring force 150 pushes the ramp connection point 138 away from the body connection point 136 (i.e., to the right in FIG. 14). As a result, the spring force 150 generates a clockwise torque on the ramp 106, which biases the ramp 106 upward towards the balanced position 128. This upward bias on the ramp 106 reduces the force that a user needs to generate to raise the ramp 106 from the closed position 124 towards the balanced position 128, thus reducing the apparent weight of the ramp 106. Reducing the apparent weight of the ramp 106 can allow a user to operate the ramp 106 without exceeding a maximum safe lifting weight, such as the maximum weight that a user is permitted to lift according to health and safety regulations. Additionally, reducing the apparent weight of the ramp 106 can allow a wider range of users to operate the ramp 106 without assistance.

FIG. 15 shows the ramp 106 in the balanced position 128. When the ramp 106 is in the balanced position 128, the spring assembly 108 is fully extended and exerts approximately no force on the ramp 106 (i.e., spring force 150 is about zero lbs or zero Newtons). Additionally, in the balanced position 128, the center of mass 154 of the ramp 106 is approximately directly above the ramp axis 120. Accordingly, in this position, the weight of the ramp 106 is fully, or near-fully, supported at the ramp axis 120 by the hinge assembly 122 and the force that a user has to generate to maintain the ramp 106 in the balanced position 128 is minimal. Since the spring assembly 108 is fully extended in the balanced position 128, the spring assembly 108 can be easily removed for maintenance or replacement when the ramp 106 is in the balanced position 128. Additionally, since the weight of the ramp 106 is fully, or near fully, supported at the ramp axis 120 by the hinge assembly 122, the ramp 106 can be kept in the balanced position 128 with minimal effort while the spring assembly 108 is temporarily removed or replaced.

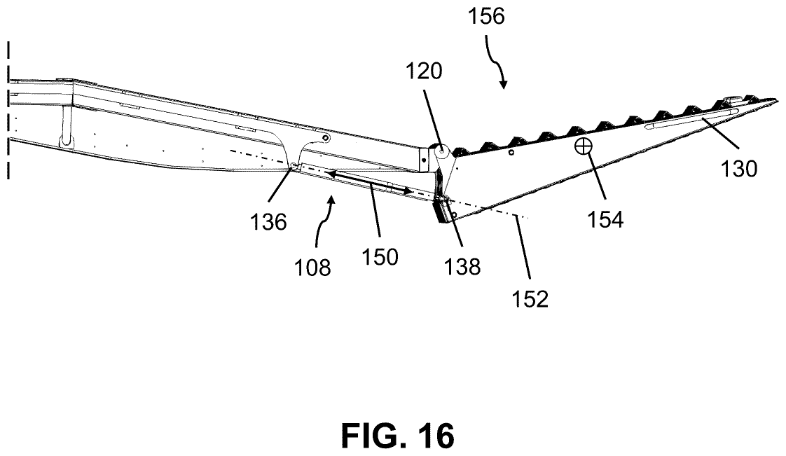

FIG. 16 shows the ramp 106 at a max moment position 156. The max moment position 156 is located between the balanced position 128 and the open position 126. The max moment position 156 corresponds to where a torque from gravity on the ramp 106 is at a maximum. When the ramp 106 is at the max moment position 156, the center of mass 154 of the ramp 106 is approximately horizontally aligned with the ramp axis 120. As a result, the force of gravity acting on the ramp 106 is generally perpendicular to its moment arm, which results in a maximum clockwise torque from gravity on the ramp 106 (as viewed in FIG. 16). In the max moment position 156, the spring assembly 108 is compressed and the spring force 150 pushes the ramp connection point 138 away from the body connection point 136. Accordingly, the spring force 150 generates a counterclockwise torque on the ramp 106 (as viewed in FIG. 16), which biases the ramp 106 upward towards the balanced position 128 and reduces the apparent weight of the ramp 106.

The apparent weight of the ramp 106 is proportional to the difference between the torque from the force of gravity that biases the ramp 106 downward (i.e., clockwise in FIG. 16) and the torque from the spring force 150 that biases the ramp 106 upward (i.e., counterclockwise in FIG. 16). Accordingly, if there was no spring force 150, the max moment position 156 would correspond to a position where the ramp 106 has a maximum apparent weight. That is, if there was no spring force 150, the max moment position 156 would correspond to a position where a user would have to exert a maximum lifting force to rotate the ramp 106 upward towards the balanced position 182.

However, in the subject embodiment, the spring force 150 generated by the spring assembly 108 increases as the spring assembly 108 is compressed. Additionally, the spring force 150 approaches perpendicular with its moment arm (i.e., approaches perpendicular with a line between the ramp connection point 138 and the ramp axis 120) as the ramp 106 rotates from the balanced position 128 towards the max moment position 156. Accordingly, in the subject embodiment, the torque from the spring force 150 that biases the ramp 106 upward increases as the ramp 106 rotates from the balanced position 128 towards the max moment position 156. This increase in torque from the spring force 150 more than offsets the increase in torque from gravity as the ramp 106 approaches the max moment position 156. Accordingly, in the subject embodiment, the max moment position 156 is not the position where the ramp 106 has a maximum apparent weight. Instead, in the subject embodiment, the position where the ramp 106 has a maximum apparent weight is located between the balanced position 128 and the max moment position 156. That is, in the subject embodiment, a user will have to exert a maximum lifting force to rotate the ramp 106 upward at a position that is located between the balanced position 128 and the max moment position 156. In other embodiments, the increase in torque from the spring force 150 may not be sufficient to offsets the increase in torque from gravity as the ramp 106 approaches the max moment position 156. In such embodiments, the max moment position 156 may still be the position where the ramp 106 has a maximum apparent weight and the user has to exert the maximum lifting force to rotate the ramp 106 upward. As will be appreciated, the position where the ramp 106 has the maximum apparent weight and the user has to exert the maximum lifting force to rotate the ramp 106 upward will depend on at least the force profile of the spring assembly 108.

To enable the ramp 106 to be operated by a user without assistance, the spring force 150 can be configured (i.e., designed or calibrated) such the lifting force that a user must exert at the middle of the lifting handle 130 does not exceed a maximum lifting limit. To that end, the spring force 150 can be configures such that, at the position where the ramp 106 has the maximum apparent weight, the maximum lifting force that a user must exert to rotate the ramp 106 upward does not exceed the maximum lifting limit. The maximum lifting limit can be a predetermined maximum weight that a user is permitted to lift for safety reasons. As will be appreciated, the maximum lifting limit may depend on local regulations or other design parameters. In some embodiments, the maximum lifting limit may be as high as 120 lbs, or may be as low as 50 lbs. In the subject embodiments, the spring force 150 is configured such that the maximum lifting force that the user must exert at the middle of the lifting handle 130 to rotate the ramp 106 from the closed position 124 to the open position 126, or vice versa, does not exceed approximately 55 lbs.

FIG. 17 shows the ramp 106 at the open position 126. When the ramp 106 is in the open position 126, the spring assembly 108 is compressed and the spring force 150 pushes the ramp connection point 138 away from the body connection point 136 (i.e., to the right in FIG. 14). As a result, the spring force 150 generates a counterclockwise torque on the ramp 106, which biases the ramp 106 upward towards the balanced position 128. This upward bias on the ramp 106 reduces the force that a user needs to generate to raise the ramp 106 from the closed position 124 towards the balanced position 128, thus reducing the apparent weight of the ramp 106. When the ramp 106 is in the open position 126, the spring assembly 108 is more compressed than at the closed position 124, at the balanced position 128, and at the max moment position 156. Accordingly, the spring force 150 is relatively high at the open position 126 and the apparent weight of the ramp 106 is relatively low. This can allow a user to easily lift the ramp 106 from the open position 126 towards the closed position 124. In a preferred embodiment, the apparent weight of the ramp 106 is approximately zero at the open position 126. In such embodiments, when a user releases the lifting handle 130 at the open position 126, the ramp 106 will rest on the ground with no force, or nearly no force.

In addition to assisting the user with opening and closing the ramp 106, the spring assembly 108 may dampen rotation of the ramp 106 about the ramp axis 120. In the subject embodiment, the gas spring 140 resists rapid compression and rapid expansion. Accordingly, the spring assembly 108 dampens rotation of the ramp 106 between the closed position 124 and the open position 126. More particularly, the spring assembly 108 dampens rapid rotation of the ramp 106 from the balanced position 128 towards the closed position 124, such as when the ramp 106 is accidentally dropped shut. Additionally, the spring assembly 108 dampens rapid rotation of the ramp 106 form the balanced position 128 towards the open position 126, such as when the ramp 106 is accidentally dropped open. Damping rotation of the ramp 106 between the balanced position 128 and at least one of the closed position 124 and the open position 126 may reduce the likelihood of injury, if the ramp 106 is accidentally dropped. Damping rotation of the ramp 106 may also reduce the likelihood of damage to the ramp 106 from an impact with the ground (if the ramp 106 is dropped open), or from an impact with the body 102 (if the ramp 106 is dropped closed).

In the subject embodiment, the damping of the spring assembly 108 is configured to stop rotation of the ramp 106 before the ramp 106 reaches the open position 126, such as when the ramp 106 is released to fall freely (i.e., dropped) from the balanced position 128 to the open position 126. Stopping the ramp 106 before it reaches the open position 126 can reduce the likelihood that a user's feet or toes will be impacted by the ramp 106, thereby increasing safety.

Although the trailer 100 is shown and described above as comprising a pair of ramps 106 and a corresponding pair of spring assemblies 108, it will be appreciated that in other embodiments the trailer may comprise at least one ramp and at least one spring assembly. For example, in some embodiments the trailer may comprise a single ramp and a single spring assembly, or a single ramp with two spring assemblies (such as one on either side of the ramp). Other combinations of the number of ramps and spring assemblies will be appreciated by a person skilled in the art.

Although the ramps 106 are shown and described above as being mirror images of each other, in other embodiments the ramps may be identical. Similarly, although the spring assemblies 108 are shown and described as being mirror images of each other, in other embodiments the spring assemblies may be identical. As will be appreciated, in embodiments where the ramps and spring assemblies are identical, one of the spring assemblies may be located between the ramps.

Although the ramps 106 are shown and described above as being rotatably connected to the rear end 114 of the body 102 at a ramp axis 120 that is generally perpendicular to the longitudinal axis of the trailer 100, in other embodiments one or more of the ramps may be rotatably connected to a longitudinal side of the body such that the ramp axis is generally parallel to the longitudinal axis of the trailer. In some embodiments, one or more of the ramps may be rotatably coupled to the rear end of the body but the ramp axis may be slightly askew from perpendicular with the longitudinal axis of the trailer, such that the ramps spread apart as they are rotated from the closed position to the open position.

Although the ramp 106 and the spring assembly 108 have been shown and described above as being coupled to the body 102 of the trailer 100, it will be appreciated by a person skilled in the art that in other embodiments the ramp and the spring assembly may be coupled to the body of other types of transport vehicles. For example, in some embodiments, the ramp may be rotatably coupled to the rear end of a body of a transport truck, such as a ramp truck or a flatbed truck, and the spring assembly may be coupled to and extend between the ramp and the body of the transport truck. As will be appreciated, the term “transport vehicle” as used herein is limited to vehicles for transporting equipment that a person skilled in the art would appreciate without difficulty are suitable for use with the ramp and the spring assembly described herein, such as a ramp truck or a flatbed truck as mentioned above.

Although embodiments have been described above and are shown in the accompanying drawings, it will be appreciated by those skilled in the art that variations and modifications may be made without departing from the scope as defined by the appended claims, and the scope of the claims should be given the broadest interpretation consistent with the specification as a whole.

What is claimed is:

1. A transport vehicle comprising:
a plurality of ground engaging elements;
a body carried by the ground engaging elements, the body having a load supporting surface;
a ramp rotatably coupled to the body, the ramp being rotatable about a ramp axis between a closed position and an open position;
a spring assembly coupled to and extending between the body and the ramp, the spring assembly exerting a spring force on the ramp along a force axis, the spring force biasing the ramp towards a balanced position located between the closed position and the open position,
wherein the spring assembly moves as the ramp rotates between the closed position and the open position such that the force axis passes by a first side of the ramp axis in the closed position, passes through the ramp axis in the balanced position, and passes by a second, opposite side of the ramp axis in the open position.

2. The transport vehicle of claim 1, wherein the transport vehicle is a trailer.

3. The trailer of claim 2, wherein the spring force biases the ramp towards the balanced position both when the ramp is in the closed position and when the ramp is in the open position.

4. The trailer of claim 2, wherein the force axis passes above the ramp axis in the closed position, and passes below the ramp axis in the open position.

5. The trailer of claim 2, wherein the spring assembly is coupled to the body at a body connection point, wherein the spring assembly is coupled to the ramp at a ramp connection point, and wherein a line between the body connection point and the ramp connection point defines the force axis.

6. The trailer of claim 5, wherein the body connection point is positioned vertically lower than the ramp axis.

7. The trailer of claim 6, wherein the ramp connection point is positioned vertically higher than the ramp axis when the ramp is in the closed position, and is positioned vertically lower than the ramp axis when the ramp is in the open position.

8. The trailer of claim 7, wherein the spring force pushes the body connection point away from the ramp connection point, when the spring assembly is compressed.

9. The trailer of claim 2, wherein the spring assembly comprises a gas spring that generates the spring force when compressed.

10. The trailer of claim 2, wherein the spring assembly comprises a compression spring that generates the spring force when compressed.

11. The trailer of claim 2, wherein the ramp comprises a lifting handle and the spring force is configured such that a maximum lifting force that the user must exert at a middle of the lifting handle to rotate the ramp from the closed position to the open position, or vice versa, does not exceed approximately 50 lbs.

12. The trailer of claim 11, wherein the maximum lifting force corresponds with the ramp being located at a position that is between a max moment position and the balanced position, wherein a center of mass of the ramp is approximately directly above the ramp axis when the ramp is in the balanced position, and wherein the center of mass of the ramp is approximately horizontally aligned with the ramp axis at the max moment position.

13. The trailer of claim 2, wherein a center of mass of the ramp is approximately directly above the ramp axis when the ramp is in the balanced position.

14. The trailer of claim 2, wherein the spring assembly is fully extended when the ramp is in the balanced position, such that the spring assembly exerts approximately no spring force on the ramp when the ramp is in the balanced position.

15. The trailer of claim 2, wherein the ramp rests against the load supporting surface of the body when the ramp is in the closed position.

16. The trailer of claim 2, wherein the spring assembly dampens rotation of the ramp between the closed position and the open position.

17. The trailer of claim 16, where the damping of the spring assembly is configured to stop rotation of the ramp before the open position, when the ramp is released to fall freely from the balanced position towards the open position.

18. The trailer of claim 2, wherein the ramp is rotatably coupled to the body by a hinge assembly, and wherein the hinge assembly comprises a single rotational joint that defines the ramp axis.

19. The trailer of claim 2, where the ramp rotates about the ramp axis by an angle greater than 90 degrees as the ramp rotate between the closed position and the open position.

20. The trailer of claim 2, wherein the ramp rotates about the ramp axis by an angle of approximately 180 degrees as the ramp rotate between the closed position and the open position.
